(19) United States
(12) Patent Application Publication
(10) Pub. No.: US 2026/0356507 A1
(43) Pub. Date: Nov. 12, 2026

(54) COLLET-SUPPORTED UMBILICAL RELEASE MECHANISM

(71) Applicant: BLUE ORIGIN MANUFACTURING, LLC, Huntsville, AL (US)

(72) Inventor: Alvaro Aguilar, Titusville, FL (US)

(21) Appl. No.: 19/202,858

(22) Filed: May 8, 2025

(51) Int. Cl. B64G 5/00

(52) U.S. Cl. CPC B64G 5/00

(57) ABSTRACT

Systems and methods disclosed herein are for collet-based section of an umbilical release mechanism (URM). The collet-based section may include inner collet segments and may be supported by an outer sleeve. The inner collet segments and the outer sleeve may be configured to support or allow a mechanical-pressure primary engagement and secondary disengagement between the collet-based section and a receiver-based section and through a receiver of the receiver-based section. The inner collet segments and the outer sleeve may be configured to also support or allow a pneumatic-pressure secondary engagement and primary disengagement between the collet-based section and through the receiver of the receiver-based section.

### TECHNICAL FIELD

The present disclosure is generally related to release mechanisms, such as umbilical release mechanisms (URMs), and methods associated therewith and, in at least one aspect, is specifically related to a collet-supported or based URM.

### BACKGROUND

Launch vehicles include various components, including umbilical release mechanisms (URMs) which may be used to allow a locked position between at least two umbilical panels. The locked position may be a latching together of the two umbilical panels. In the locked position, various media may be transferred through other connections between the two the two umbilical panels and between launch vehicle and ground features hosting the two umbilical panels. The URMs may be heavily used and may need extensive refurbishing after use. The URMs may offer redundant triggers which may not be fault-tolerant for human-rated flights.

### SUMMARY

In one non-limiting example, a system for release mechanism may include a first section and a second section to be used with a launch vehicle and a ground feature. The release mechanism may be a collet-supported or based umbilical release mechanism (URM) or may be associated with a collet-supported or based URM. The collet-supported or based URM may include a fault-tolerant mechanical-pressure primary engagement and secondary disengagement release mechanism, and a pneumatic-pressure secondary engagement and primary disengagement release mechanism. The collet-supported or based URM may be fault-tolerant for human-rated flights, may be heavily used, and may not need extensive refurbishing after each use as there may be reduced components or moving parts.

The first section and the second section may be located on different umbilical panels for the launch vehicle and the ground feature. The collet-supported or based URM may support or allow coupling of the umbilical panels into a locked position by a union of the first section and the second section of the collet-supported or based URM. The locked position of the umbilical panels may allow transfer of media to be performed between the launch vehicle and the ground feature. The union of the umbilical panels, by virtue of the collet-supported or based URM, may be able to withstand high loads. A footprint of the system may support retrofitting of the collet-supported or based URM into a URM provision of the umbilical panels, in one example. The system may be reusable and may not need refurbishment of parts. At least the pneumatic-pressure secondary engagement and primary disengagement release mechanism and the fault-tolerant mechanical-pressure primary engagement may be used for a routine transfer of the media, while the mechanical-pressure secondary disengagement release mechanism may be used for an emergency or back-up disengagement of the umbilical panels.

The system may include a receiver in the first section, with the receiver configured to bias outer collet segments, which are within the receiver. The bias may be so that the outer collet segments may be in a locked position along with the first section and the second section. The system may include inner collet segments and an outer sleeve of the second section. The inner collet segments and the outer sleeve may also be configured to support or allow a mechanical-pressure primary engagement and secondary disengagement between the first section and the second section and through the receiver. The inner collet segments and the outer sleeve may be configured to support or allow a pneumatic-pressure secondary engagement and primary disengagement between the first section and the second section and through the receiver.

In one non-limiting aspect, the disclosure herein is for a collet-based section of an umbilical release mechanism (URM). The collet-based section of a URM may include inner collet segments and may be supported by an outer sleeve. The inner collet segments and the outer sleeve may be configured to support or allow a mechanical-pressure primary engagement and secondary disengagement between the collet-based section and a receiver-based section and through a receiver of the receiver-based section. The inner collet segments and the outer sleeve may also be configured to support or allow a pneumatic-pressure secondary engagement and primary disengagement between the collet-based section and through the receiver of the receiver-based section.

In another non-limiting aspect, the disclosure herein is for a method for a release mechanism. The method may include determining to associate together a first section and a second section of the release mechanism. The method may include biasing, using a receiver in the first section, outer collet segments, which is within the receiver, to be in a locked position along with the first section and the second section. The method may include supporting or allowing a mechanical-pressure primary engagement and secondary disengagement between the first section and the second section using the inner collet segments, the outer collet segments, and an outer sleeve which is associated with the second section. The method may also include supporting or allowing a pneumatic-pressure secondary engagement and primary disengagement between the first section and the second section using inner collet segments, the outer collet segments, and an outer sleeve which is associated with the second section.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a system for a collet-supported or based release mechanism, in accordance with at least one non-limiting aspect of the present disclosure;

FIG. 2A illustrates cross-section aspects associated with lock ports in a collet-supported or based release mechanism, in accordance with a further non-limiting aspect of the present disclosure;

FIG. 2B illustrates cross-section aspects associated with unlock ports in a collet-supported or based release mechanism, in accordance with a further non-limiting aspect of the present disclosure;

FIG. 2C illustrates cross-section aspects of a collet-based section in a locked position, in accordance with a further non-limiting aspect of the present disclosure;

FIG. 2D illustrates cross-section aspects of a collet-based section in an unlocked position, in accordance with a further non-limiting aspect of the present disclosure;

FIG. 2E illustrates aspects of a receiver-based section of a collet-supported or based release mechanism, in accordance with a further non-limiting aspect of the present disclosure;

FIG. 2F illustrates further cross-section aspects of a collet-supported or based release mechanism in a locked position, in accordance with a further non-limiting aspect of the present disclosure;

FIG. 2G illustrates further cross-section aspects of a collet-supported or based release mechanism in an unlocked position, in accordance with a further non-limiting aspect of the present disclosure;

FIG. 3A illustrates external aspects of a collet-supported or based release mechanism, in accordance with a further non-limiting aspect of the present disclosure;

FIG. 3B illustrates further external aspects of a housing in a collet-supported or based release mechanism, in accordance with a further non-limiting aspect of the present disclosure;

FIG. 3C illustrates aspects of a piston in a collet-supported or based release mechanism, in accordance with a further non-limiting aspect of the present disclosure;

FIG. 4 illustrates an example space mission having components benefiting from the collet-supported or based release mechanism, in accordance with a further non-limiting aspect of the present disclosure;

FIG. 5 illustrates a method associated with a system used for collet-supported or based release mechanism, in accordance with a further non-limiting aspect of the present disclosure; and

FIG. 6 illustrates a further method associated with a system used for collet-supported or based release mechanism, in accordance with a further non-limiting aspect of the present disclosure.

### DETAILED DESCRIPTION

As human-launches may need redundancies for safety reasons, a system for a collet-supported or based release mechanism herein may be a collet-supported or based umbilical release mechanism (URM). The collet-supported or based URM may include a combination of a fault-tolerant mechanical-pressure primary engagement and secondary disengagement release mechanism and a pneumatic-pressure secondary engagement and primary disengagement release mechanism. The collet-supported or based URM may be able to support higher than tens of thousands of pounds in a few dozen square inches of a footprint, for instance, with respect to tensile capacity to withstand without a premature separation. In addition, the collet-supported or based URM may be able to support a varying amount of tensile capacity which may be provided within a limited space of at least a pair of umbilical panels between a ground feature (such as of a launchpad) and a launch vehicle.

In one example, the engagement may be in reference to a first feature (such as a ground feature) having a first section of a collet-supported or based URM being engaged with a second feature (such as a launch vehicle feature) having a second section of the collet-supported or based URM. The engagement may be so that transfer or media may be performed between the first feature and the second feature. The media may include tangible media (such as liquid and gases), as well as non-tangible media (such as communication and power). The media itself may be transferred by respective connectors suitable to the media at issue.

The disengagement may be in reference to the first feature being disengaged from the second feature by the collet-supported or based URM being separated after the media transfer is completed, as part of a routine transfer, or after or before the media transfer is completed in the case of emergency. In one example, the primary engagement, primary disengagement, and secondary engagement may be part of the routine transfer of media. In one example, the secondary disengagement may be part of the case of emergency or a back-up for redundancy to the primary disengagement. At least the primary engagement and the primary disengagement are pneumatic. At least the secondary engagement and the secondary disengagement are mechanical. In one example, the secondary engagement may include a locked position for some aspects of the collet-supported or based URM but may not include a locked position for the collet-supported or based URM. In this example, it is the primary engagement which provides the locked position for the collet-supported or based URM.

While ball-bearings may be used in a URM, they may offer limited surface area the tensile capacity capable within a collet-supported or based URM. In addition, a URM having solid segments may not be flexible, but spherical surfaces and conical structures may support an element of flexibility in a URM. In at least one example, the collet-supported or based URM herein may include a receiver in the receiver-based section. The receiver may be configured to bias outer collet segments, which are within the receiver. The bias may be performed for the outer collet segments to be in a locked position along with the receiver-based section and a collet-based section. There may be inner collet segments and an outer sleeve in the second section. The inner collet segments and the outer sleeve may be configured to support or allow a mechanical-pressure primary engagement and secondary disengagement between the first section and the second section, and through the receiver. The inner collet segments and the outer sleeve may also be configured to support or allow a pneumatic-pressure secondary engagement and primary disengagement between the first section and the second section, and through the receiver.

The collet-supported or based URM herein may include lock ports to receive media at a pressure associated with the pneumatic-pressure secondary engagement before a primary engagement is performed. The collet-supported or based URM herein may include unlock ports to receive a media at a pressure for the pneumatic-pressure primary disengagement. The media may be a same media and the pressure may be predetermined for the pneumatic-pressure secondary engagement and primary disengagement. The collet-supported or based URM may include a piston which is within a housing and which may be movable between a locked position and an unlocked position based on the media applied to the lock ports or the unlock ports. The piston may include a knob at an end. The knob may be between the inner collet segments in the locked position. The outer sleeve may be configured, as part of the mechanical-pressure primary engagement, to retain the outer collet segments and the inner collet segments in the locked position.

When the outer sleeve is removed as part of the mechanical-pressure secondary disengagement, the outer collet segments may be configured to be in an unlocked position, along with the inner collet segments, the first section, and the second section. When the piston is moved to the unlocked position as part of the pneumatic-pressure primary disengagement, the inner collet segments may be configured to collapse, and the first section and the second section may be in the unlocked position. For the unlocking, using the pneumatic-pressure primary disengagement, the unlock ports may be able to receive media with enough pressure to overcome friction which may be at least between the knob at the end of the piston and of inner collet segments. The piston may be moved to the unlocked position by the media alone.

In one example, a threaded retainer, which may be operated by remote or human operation, may be used to remove loading on the collet-supported or based URM once the sections 106A, 106B are in a locked position. The threaded retainer may be able to remove any loading on the collet-supported or based URM when the receiver-based section and the collet-based section are together in the locked position. The threaded retainer may also remove the load on any bellows associated with the collet-supported or based URM. In one example, the preload may be represented by a thousandth of an inch of movement so that the piston or housing and the threaded retainer may be moved together as part of the preloading from the threaded retainer. In addition, in areas near cryogenic activities, all areas (such as internals) of the collet-supported or based URM may need venting. For example, liquid hydrogen (H₂) may be flowing in the areas and there may be a possibility for condensation and icing within the areas. The collet-supported or based URM may include purge capability and may use gaseous helium (He) or nitrogen for purging the areas. Helium may be preferred for applications where a temperature around the collet-supported or based URM is expected to be near-cryogenic state, while nitrogen gas may be sufficient for a collet-supported or based URM in non-near-cryogenic environments. One or more of the materials in the collet-supported or based URM may include a nickel alloy, a composite of nickel alloy, copper-beryllium, a composite of copper-beryllium, or stainless steel. In some examples, copper-beryllium may be used at least because of its non-sparking properties. The one or more materials may include materials having a high yield strength, in one example. One or more of the materials in the collet-supported or based URM may include high strength corrosion resistant materials such as a high-strength, high-temperature, and precipitation-hardening iron-nickel-chromium alloy (such as A-286), or may include stainless steel or aluminum-bronze. At least aluminum-bronze may be used due to its anti-galling properties.

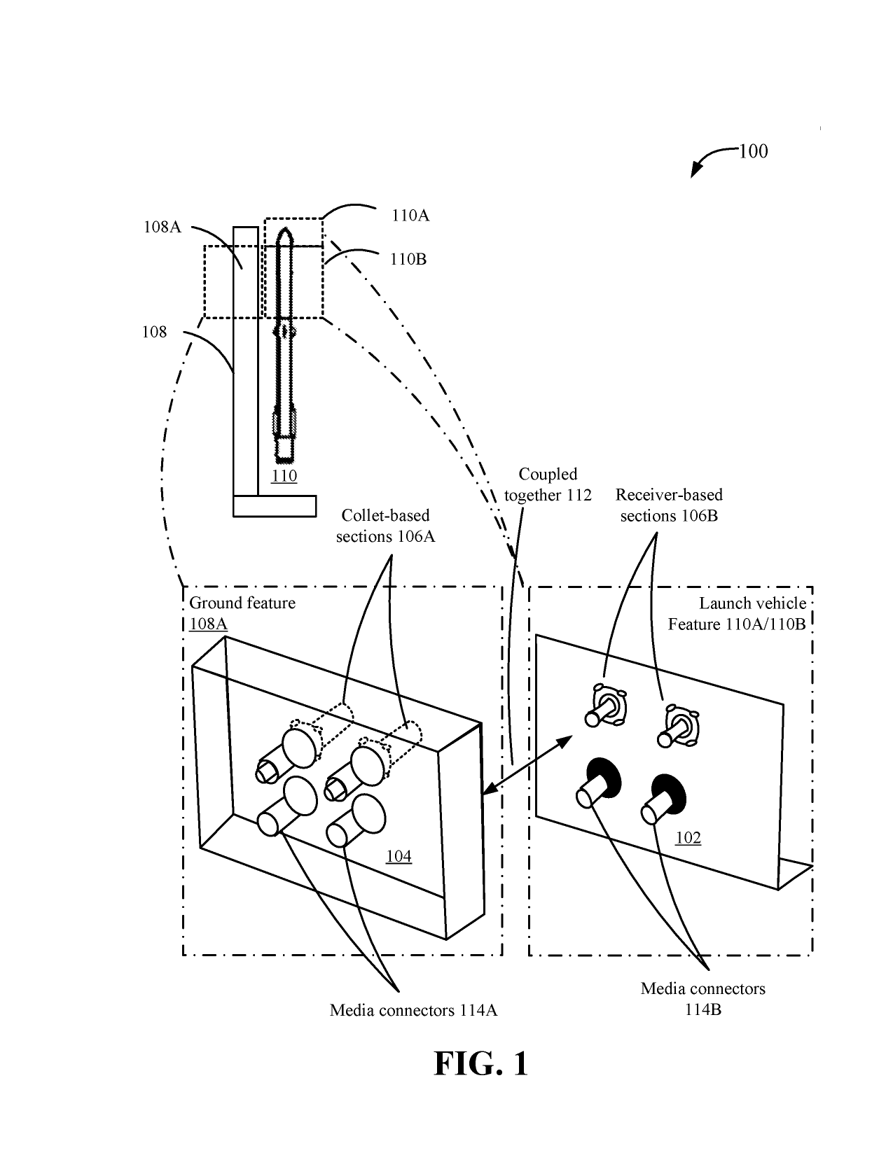

FIG. 1 illustrates a system 100 for a collet-supported or based release mechanism or URM, in accordance with at least one non-limiting aspect of the present disclosure. The system 100 may include umbilical panels 102, 104 on opposing features, such as a ground feature 108A of a launchpad 108 and a launch vehicle feature 110A, 110B of a launch vehicle 110. The launch vehicle feature 110A, 110B may include a stage of a launch vehicle. The stage may include one or more modules for communications, humans, or cargo (sometimes referred to as payload), and may include a propellant or fuel tank. The umbilical panels 102, 104 may include respective sections 106A, 106B of a collet-supported or based URM. The respective sections may include one or more collet-based sections 106A which may be coupled together 112 with respective ones of receiver-based sections 106B. The collet-based sections 106A may be on an umbilical panel 104 of a ground feature 108A. The receiver-based sections 106B may be on an umbilical panel 102 of a launch vehicle feature 110A, 110B (excerpts of which are illustrated in the callout sections).

The collet-supported or based URM may be used to hold together essential connections between the launchpad 108 and a launch vehicle 110, prior to a launch. In one example, the ground feature 108A and the launch vehicle feature 110A, 110B may be associated with fuel umbilical panels (for example, liquid hydrogen and liquid oxygen), electrical power connection umbilical panels, communications and data transfer umbilical panels, coolant umbilical panels, purge gases (for example, nitrogen and helium) umbilical panels, and others. The fuel, electrical power connection, communications and data transfer, coolant, purge gases, and the like may be provided by respective connectors 114A, 114B, once the umbilical panels 102, 104 are coupled together 112 in a locked position using one or more collet-based sections 106A and receiver-based sections 106B of a collet-supported or based URM.

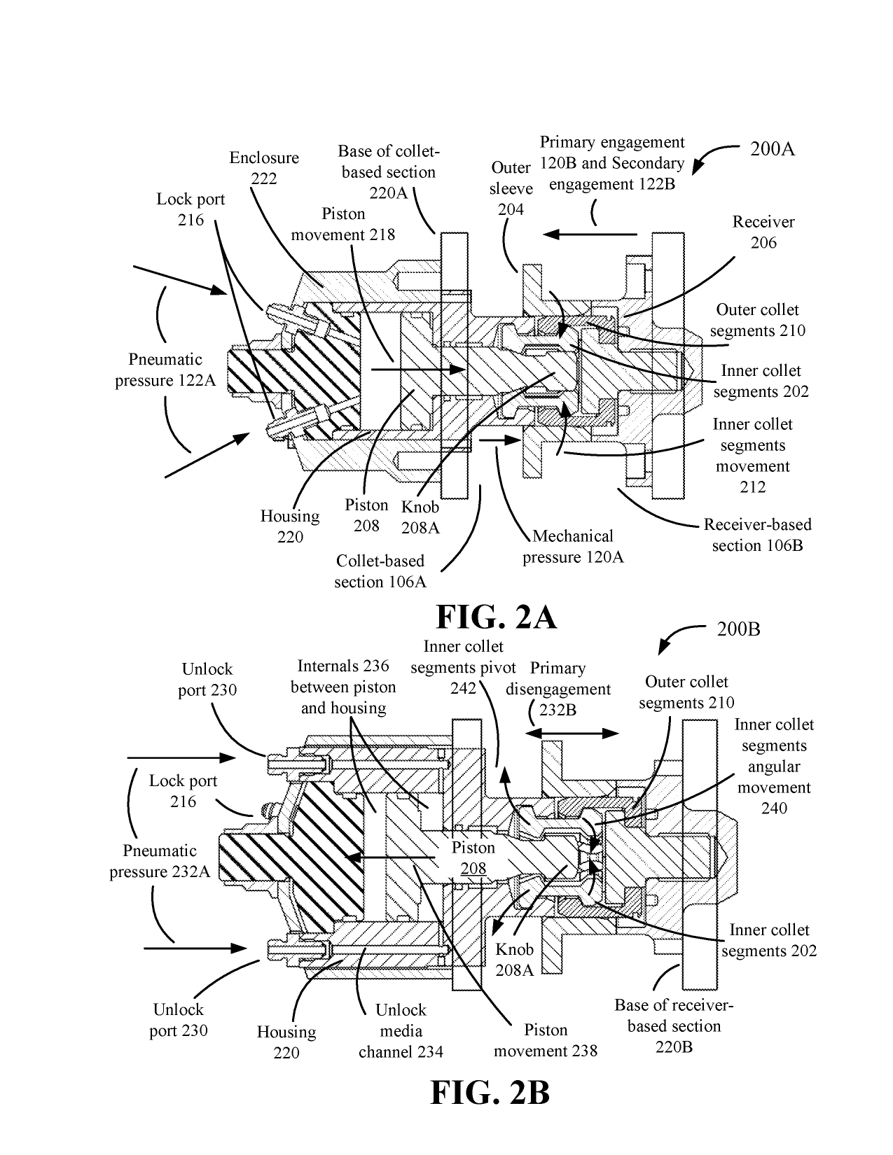

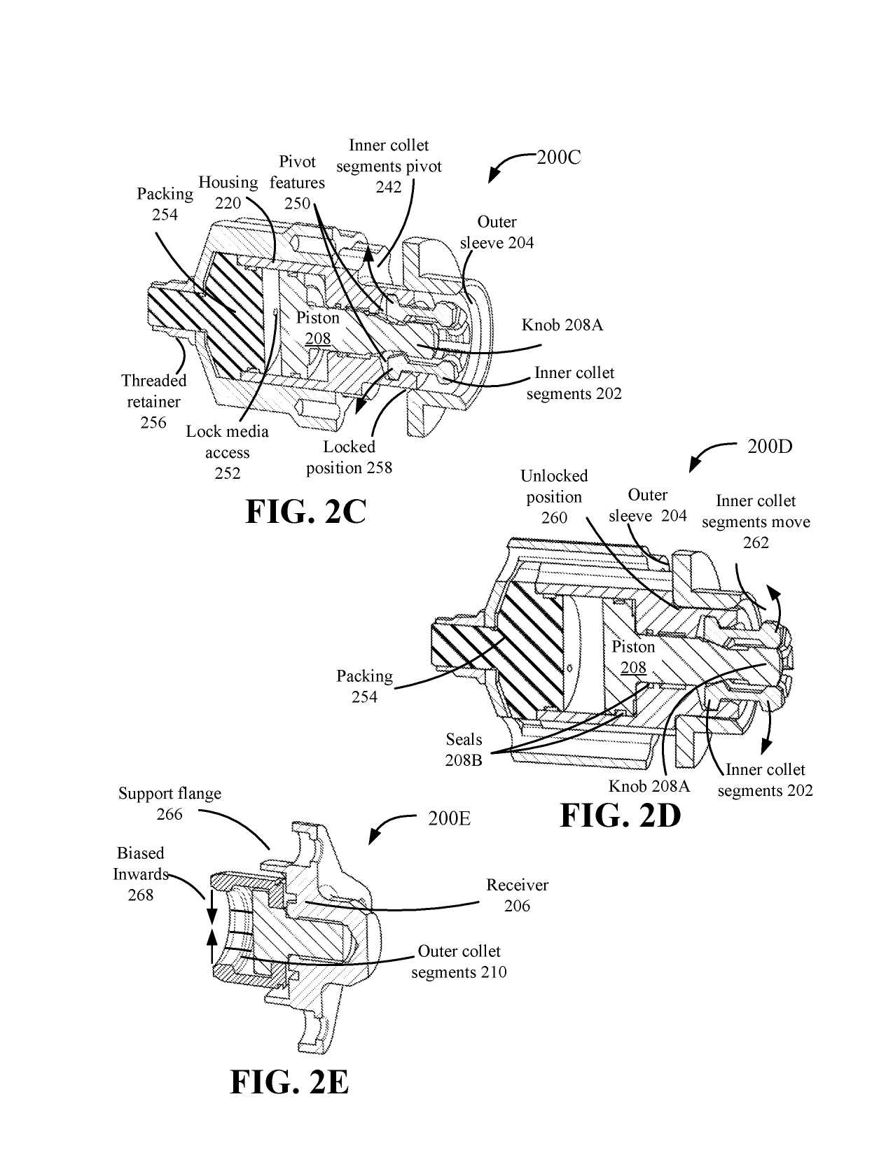

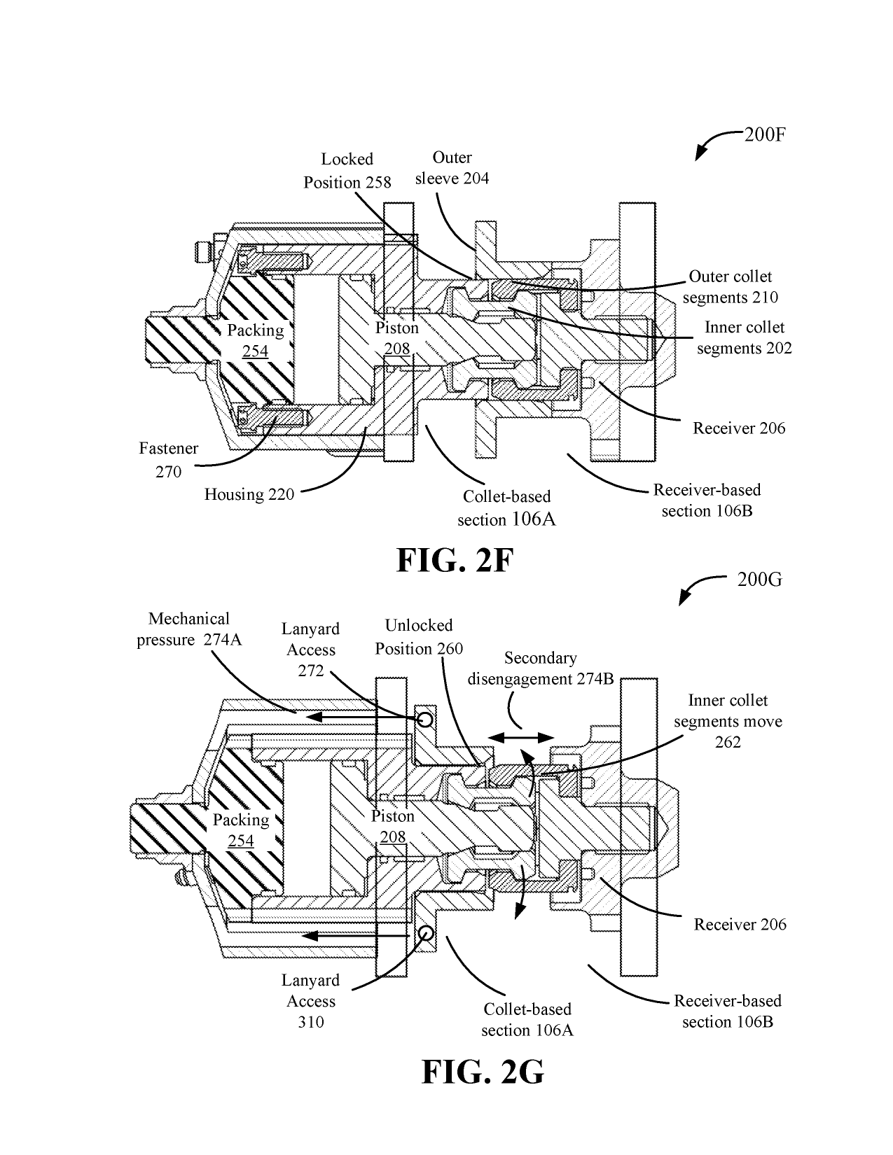

FIG. 2A illustrates cross-section aspects 200A associated with lock ports of a collet-supported or based release mechanism or URM, in accordance with a further non-limiting aspect of the present disclosure. The collet-supported or based URM may include a collet-based section 106A and a receiver-based section 106B. The collet-based section 106A may include inner collet segments 202 and an outer sleeve 204. The inner collet segments 202 and the outer sleeve 204 may be configured to support or allow a mechanical-pressure primary engagement and secondary disengagement between the collet-based section 106A and the receiver-based section 106B, and through the receiver 206. The inner collet segments 202 and the outer sleeve 204 may be configured to support or allow a pneumatic-pressure secondary engagement and primary disengagement between the collet-based section 106A and the receiver-based section 106B, and through a receiver 206 of the receiver-based section 106B.

In one example of operation, a media may be applied to a lock port 216, from a media source, to begin locking together sections 106A, 106B of the collet-supported or based URM. There may be one or more lock ports 216, in one example. The lock ports 216 may be provided through an enclosure 222 of the collet-supported or based URM. The media may be presented as pneumatic pressure 122A to the lock port 216. The media may enter the internals 236 (in FIG. 2B) between the piston 208 and the housing 220, at a top of the piston 208. The media may cause a piston movement 218 to a piston 208, within a housing 220, towards the receiver 206.

The piston movement 218 may be part of the secondary engagement 122B allowed by the pneumatic pressure 122A applied to the lock ports 216, as a knob 208A of the piston 208 may be exposed and ready to be captured and retained by the receiver 206. The presentation of the pneumatic pressure 122A to the lock port 216 and the allowance to the piston 208 to be exposed and to be captured and retained by the receiver 206, may altogether represent a pneumatic-pressure secondary engagement herein. In this example, the secondary engagement 122B may include a locked position for some aspects of the collet-supported or based URM (such as the piston 208) but may not include a locked position for the collet-supported or based URM.

To continue the operation, the receiver 206 of the receiver-based section 106B may be configured to capture and retain the knob 208A of the piston 208 of the collet-based section 106A. The receiver 206 may allow or support a bias to outer collet segments 210, which are within the receiver 206. The bias to the outer collet segments 204 may be provided, in part, from the outer sleeve 204, in one example. In another example, the bias may be already within the outer collet segments 204, as described in connection with at least FIG. 2E. The outer sleeve 204 may be moved towards the receiver 206, representing a mechanical pressure in the collet-supported or based URM. The outer sleeve 204 may cause an inner collet segments movement 212 towards the piston 208 and may provide circumferential pressure to the inner collet segments 202, in one example. There may be circumferential pressure from the bias in the outer collet segments 210 alone, in another example. The inner collet segments movement 212 may also be part of the mechanical pressure in the collet-supported or based URM and may provide circumferential pressure to the inner collet segments 202.

In operation, the bias to the outer collet segments 204 may be such that the outer collet segments 204 are positioned in a locked position, along with the sections 106A, 106B. The primary engagement 120B, based in part on the mechanical pressure 120A, may provide the locked position for the collet-supported or based URM. As the mechanical pressure 120A supports or allows the bias to the outer collet segments 204 to be in the locked position, it may represent a mechanical-pressure primary engagement which may be performed after the pneumatic-pressure secondary engagement herein.

In addition, as the inner collet segments 202 and the outer sleeve 204 allow a pneumatic pressure 122A to cause the piston 208 to be exposed for a secondary engagement 122B, before the receiver 206 is engaged, the inner collet segments 202 and the outer sleeve 204 are configured to support or allow a pneumatic-pressure secondary engagement between the receiver-based section 106B and the collet-based section 106A, and through the receiver 206. Further, as the inner collet segments 202 and the outer sleeve 204 allow a mechanical pressure 120A to perform one or more of a bias or an application of circumferential pressure to the piston 208, the inner collet segments 202 and the outer sleeve 204 are configured to support or allow a mechanical-pressure secondary engagement between the receiver-based section 106B and the collet-based section 106A, and through the receiver 206.

FIG. 2B illustrates cross-section aspects 200B associated with unlock ports in a collet-supported or based release mechanism or URM, in accordance with a further non-limiting aspect of the present disclosure. There may be more than one unlock port 230 in the collet-supported or based URM. The unlock port 230 may also be through an enclosure 222 of the collet-based section 106A of the collet-supported or based URM. In operation, the unlock port 230 may be configured to receive media, from a media source, for a pneumatic-pressure primary disengagement. The media for the unlock port 230 may be the same or a different media than the media for the lock port 216, in one example. The media for the lock port 216, the unlock port 230, or for any purging performed in the collet-supported or based URM may be different than the media transferred between the features 108A, 110A, 110B of the system 100 in FIG. 1. The purging, in one example, may be performed through one or more of the lock port 216 or the unlock port 230.

FIG. 2B illustrates that the media may be presented as a pneumatic pressure 232A at the unlock port 230. The media may travel from the unlock port 230, through an unlock media channel 234 of the housing 220. The media may enter the internals 236 between the piston 208 and the housing 220. For at least the unlocking, the media enters under the piston 208 and may cause a piston movement 238 which is away from the receiver 206. The knob 208A of the piston may dislodge from the inner collet segments 202. The inner collet segments may be subject to an inner collet segments angular movement 240 resembling, at least in part, a collapse of the inner collet segments 202. For example, the inner collet segments angular movement 240 may be supported by a pivot at one end of the inner collet segments 202. In another example, the inner collet segments angular movement 240 may be supported by a bias towards the piston 208 held by the outer collet segments 210, which may pressure a bottom portion of the inner collet segments 202 towards the knob 208A. The pivot allows a top portion of the inner collet segments 202 to rotate away from the piston 208 while the bottom portion of the inner collet segments collapse towards the piston 208. The collapse may cause disengagement between the inner collet segments 202 and the outer collet segments 210, as the piston 208 moves away from the receiver 206.

The outer collet segments 210 and the outer sleeve 204 may remain in place while the inner collet segments 202 collapse. The disengagement between the inner collet segments 202 and the outer collet segments 210 may cause the primary disengagement 232B between the sections 106A, 106B of the collet-supported or based URM. Further, as the inner collet segments 202 collapses but the outer sleeve 204 remains in place to keep the outer collet segments 210 in place, the inner collet segments 202 and the outer sleeve 204 are configured to support or allow a pneumatic-pressure primary disengagement between the sections 106A, 106B of the collet-supported or based URM, and through the receiver 206. FIGS. 2A and 2B also illustrate that each section 106A, 106B may include a respective base 220A, 220B to couple the sections 106A, 106A to an intended feature 108A, 110A, 110B of the launch vehicle 110 or launchpad 108 (as in FIG. 1).

FIGS. 2A and 2B illustrate at least one lock port 216 which may be configured to receive first media for the pneumatic-pressure secondary engagement. FIGS. 2A and 2B also illustrate that the collet-supported or based URM may include at least one unlock port 230 configured to receive second media for the pneumatic-pressure primary disengagement. The collet-supported or based URM may include the outer sleeve 204 which may bias, as part of the mechanical-pressure primary engagement, the inner collet segments 202 with the outer collet segments 210. The bias may be when the inner collet segments 202 and the outer collet segments 210 are in the locked position. The collet-supported or based URM is such that, when the outer sleeve is removed as part of the mechanical-pressure secondary disengagement, the outer collet segments 210 may be in an unlocked position, along with the inner collet segments 202, the receiver-based section 106B, and the collet-based section 106A.

FIGS. 2A and 2B illustrate that the piston 208 may be configured to receive media for the pneumatic-pressure secondary engagement and primary disengagement. The housing 220 may be configured to allow movement of the piston 208 therein and to support angular movement 240 for the inner collet segments 202. At least one of the angular movement 240 may cause the inner collet segments 202 to collapse as part of the pneumatic-pressure primary disengagement. FIGS. 2A and 2B also illustrate a knob 208A at an end of the piston 208, and which may be between the inner collet segments 202. The outer sleeve 204 may be configured to retain the outer collet segments 210 and the inner collet segments 202 in the locked position as part of the mechanical-pressure primary engagement. When the outer sleeve 204 is removed, as part of the mechanical-pressure secondary disengagement, the outer collet segments 210 may be in an unlocked position, along with the inner collet segments 202, the receiver-based section 106B, and the collet-based section 106A.

FIG. 2C illustrates cross-section aspects 200C of a collet-based section in a locked position, in accordance with a further non-limiting aspect of the present disclosure. In the locked position 258 for the outer sleeve 204, the outer sleeve 204 is over the inner collet segments 202 (and over the outer collet segments 210 of the receiver 206, as in FIG. 2A). Media may be maintained through the lock port, as also detailed in connection with FIG. 2A, and may be maintained on the piston 208 through a lock media access 252 provided in a packing 254. In one example, once a locked position is attained using the media, a threaded retainer 256 may be used to maintain the locked position with the media removed from the lock port. The threaded retainer 256 may be used to remove loading on the collet-supported or based URM once the sections 106A, 106B are in a locked position. The threaded retainer 256 may be able to remove more than 30 K lbs. of loading on the collet-supported or based URM when the receiver-based section and the collet-based section are together in the locked position. The threaded retainer 256 may also remove the load on any bellows associated with the collet-supported or based URM. In one example, the preload may be represented by a thousandth of an inch of movement so that the piston 208 or housing 220 and the threaded retainer 256 may be moved together as part of the preloading from the threaded retainer.

FIG. 2C also illustrates that pivot features 250 within the collet-based section 106A of the collet-supported or based URM. In the locked position, a mechanical-pressure primary engagement and a pneumatic-pressure secondary engagement may be supported by the threaded retainer 256. When unlocking is to be performed, as part of the pneumatic-pressure primary disengagement herein, the threaded retainer 256 may be disengaged first. Then, media may be applied to the unlock port 230, as detailed in connection with FIG. 2B. The piston 208 may move away from the receiver 206, which may cause the knob 208A of the piston 208 to pull against a top of the inner collet segments 202. FIGS. 2A-2C also illustrate that a packing 254 having a lock port access 252 may be attached to the housing 220. The packing 254 may be configured to retain the piston 208 within the housing 220 and to provide space (such as the internals 236 in FIGS. 2A and 2B) to receive the media.

The knob 208A pulling against a top of the inner collet segments 202 may support the inner collet segments pivot 242 which may occur to the inner collet segments 202. There may be pivot features 250 in the collet-based section 106A to support such an inner collet segments pivot 242. In one example, the pivot features 250 includes curved edges between tops of the inner collet segments 202, cured edges of the knob 208A, curved edges of the housing 220, and room above the top of the inner collet segments 202 to allow the inner collet segments pivot 242 for at least the top of the inner collet segments 202, away from the piston 208. The outer sleeve 204 may remain in place, along with the outer collet segments 210 of the receiver 206. This may represent the pneumatic-pressure primary disengagement which may be used for a routine transfer of the media. Once disengaged, the outer sleeve 204 may be moved to an unlocked position (as in FIG. 2D) to reset the collet-based section 106A and the collet-supported or based URM may be reused.

FIG. 2D illustrates cross-section aspects 200D in an unlocked position of a collet-based section, in accordance with a further non-limiting aspect of the present disclosure. In the unlocked position 260 for the outer sleeve 204, the outer sleeve 204 is not over the inner collet segments 202 (and not over the outer collet segments 210 of the receiver 206, as in FIG. 2A). The unlocked position 260 may be after a resetting of the collet-based section 106A or may be part of a mechanical-pressure secondary disengagement performed in the collet-supported or based URM, which is detailed further in connection with at least FIG. 2G. FIG. 2D also illustrates that the piston 208 may include seals 208B to retain any media to areas (top or bottom) of the piston, as intended for locking and for unlocking.

FIG. 2D also illustrates that, in the absence of the outer sleeve 204 over the inner collet segments 202 and irrelevant to piston 208 being exposed in the locked position, the inner collet segments 202 may move 262 away from the piston 208. The move 262 may be sufficient to overcome a bias from the outer collet segments 210 which may be towards the piston 208 to maintain the locked position for the inner collet segments 202. With the bias overcome, there may be a disengagement between the inner collet segments 202 and the outer collet segments 210, as the outer sleeve 204 is moved away from the receiver 206. The removal of the outer sleeve 204 at least represents a mechanical pressure to cause the secondary disengagement in the collet-supported or based URM, which is detailed further in connection with at least FIG. 2G. In addition, because removal of the outer sleeve 204 by a mechanical pressure causes the inner collet segments 202 to move 262 outwards for the secondary disengagement, the inner collet segments 202 and an outer sleeve 204 allow or support the mechanical-pressure secondary disengagement.

FIG. 2E illustrates aspects 200E of a receiver-based section in a collet-supported or based release mechanism, in accordance with a further non-limiting aspect of the present disclosure. The receiver-based section 206 may include a support flange 266 for the outer collet segments 210. The outer collet segments may include a bias inwards 268, towards a piston 208 of the collet-based section 106A. The bias may allow the outer collet segments 210 to maintain a locked position for the inner collet segments 202 against the piston 208. With the bias overcome by removal of the outer sleeve 204, for instance, there may be a disengagement between the inner collet segments 202 and the outer collet segments 210 for the mechanical-pressure secondary disengagement. Separately, when the bias is sufficient to collapse the inner collet segments 202 towards the piston 208 as the piston 208 moves away from the receiver 206, there may also be a disengagement between the inner collet segments 202 and the outer collet segments 210 for the pneumatic-pressure primary disengagement.

FIG. 2F illustrates cross-section aspects 200F in a locked position for a collet-based section, in accordance with a further non-limiting aspect of the present disclosure. In one example of operation, as detailed in connection with at least FIG. 2A, a media applied to a lock port may be used to begin locking together sections 106A, 106B of the collet-supported or based URM. The media may enter the internals 236 (in FIG. 2B) between the piston 208 and the housing 220, at a top of the piston 208. The media may cause a piston movement to the piston 208, within a housing 220 and towards the receiver 206. FIG. 2F also illustrates that the packing 254 may be associated with the housing 220 via the cylinder type fasteners 270. This at least maintains respective positions for one or more of the packing 254 or the housing 220 within the enclosure 222 of the collet-supported or based URM.

The piston movement may be part of the secondary engagement allowed by the pneumatic pressure as a knob of the piston 208 may be exposed to be captured and retained by the receiver 206. In this example, the secondary engagement may include a locked position for some aspects of the collet-supported or based URM (such as the piston 208) but may not include a locked position for the collet-supported or based URM. To continue the operation, the receiver 206 of the receiver-based section 106B may be configured to capture and retain the knob 208A of the piston 208 of the collet-based section 106A.

The receiver 206 may allow or support a bias to outer collet segments 210, which are within the receiver 206. The bias to the outer collet segments 204 may be provided, in part, from the outer sleeve 204, in one example, or may be already within the outer collet segments 204, as described in connection with at least FIG. 2E. The outer sleeve 204 may be moved towards the receiver 206, representing a mechanical pressure 120A in the collet-supported or based URM. The outer sleeve 204 may cause an inner collet segments movement towards the piston 208 and may provide circumferential pressure to the inner collet segments 202, in one example. The inner collet segments movement may also be part of the mechanical pressure in the collet-supported or based URM and may provide circumferential pressure to the inner collet segments 202. In operation, the bias to the outer collet segments 204 may be such that the outer collet segments 204 are positioned in a locked position, along with the sections 106A, 106B. The primary engagement, based in part on the mechanical pressure, may provide the locked position for the collet-supported or based URM. As described in connection with FIG. 2A, the mechanical pressure supports or allows the bias to the outer collet segments 204 to be in the locked position, representing a mechanical-pressure primary engagement which may be performed after the pneumatic-pressure secondary engagement herein.

FIG. 2G illustrates cross-section aspects 200G in an unlocked position for a collet-supported or based release mechanism, in accordance with a further non-limiting aspect of the present disclosure. The cross-section aspects 200G may be directed to the mechanical-pressure secondary disengagement used for an emergency or back-up disengagement of umbilical panels, in one example. FIG. 2G illustrates that the outer sleeve 204 may include a lanyard access 272 to allow a mechanical pressure 274A to the outer sleeve 204 and through a lanyard, in one example. There may be other associations to the outer sleeve 204 to provide the same mechanical pressure 274A, when needed, relative to a lanyard through the lanyard access 272.

The outer sleeve 204 may be pulled away from the receiver 206. In the absence of the outer sleeve 204 over the inner collet segments 202 and irrelevant to piston 208 being exposed in the locked position, the inner collet segments 202 may move 262 away from the piston 208. The move 262 may be sufficient to overcome a bias from the outer collet segments 210 which may be towards the piston 208 to maintain the locked position for the inner collet segments 202. With the bias overcome, there may be a disengagement between the inner collet segments 202 and the outer collet segments 210, as the outer sleeve 204 is moved away from the receiver 206.

The removal of the outer sleeve 204 at least represents a mechanical pressure 274A to cause the secondary disengagement 274B in the collet-supported or based URM. In addition, because removal of the outer sleeve 204 by a mechanical pressure 274A causes the inner collet segments 202 to move 262 outwards for the secondary disengagement 274B, the inner collet segments 202 and an outer sleeve 204 allow or support the mechanical-pressure secondary disengagement. Further, the mechanical pressure 274A may be associated with the secondary disengagement 274B and may be higher than a second pressure associated with one or more of the pneumatic-pressure secondary engagement or the mechanical-pressure primary engagement, described in connection with at least FIG. 2A. This may allow the emergency or back-up disengagement with or without removal of the pneumatic pressure to the lock ports or removal of the outer sleeve, for instance.

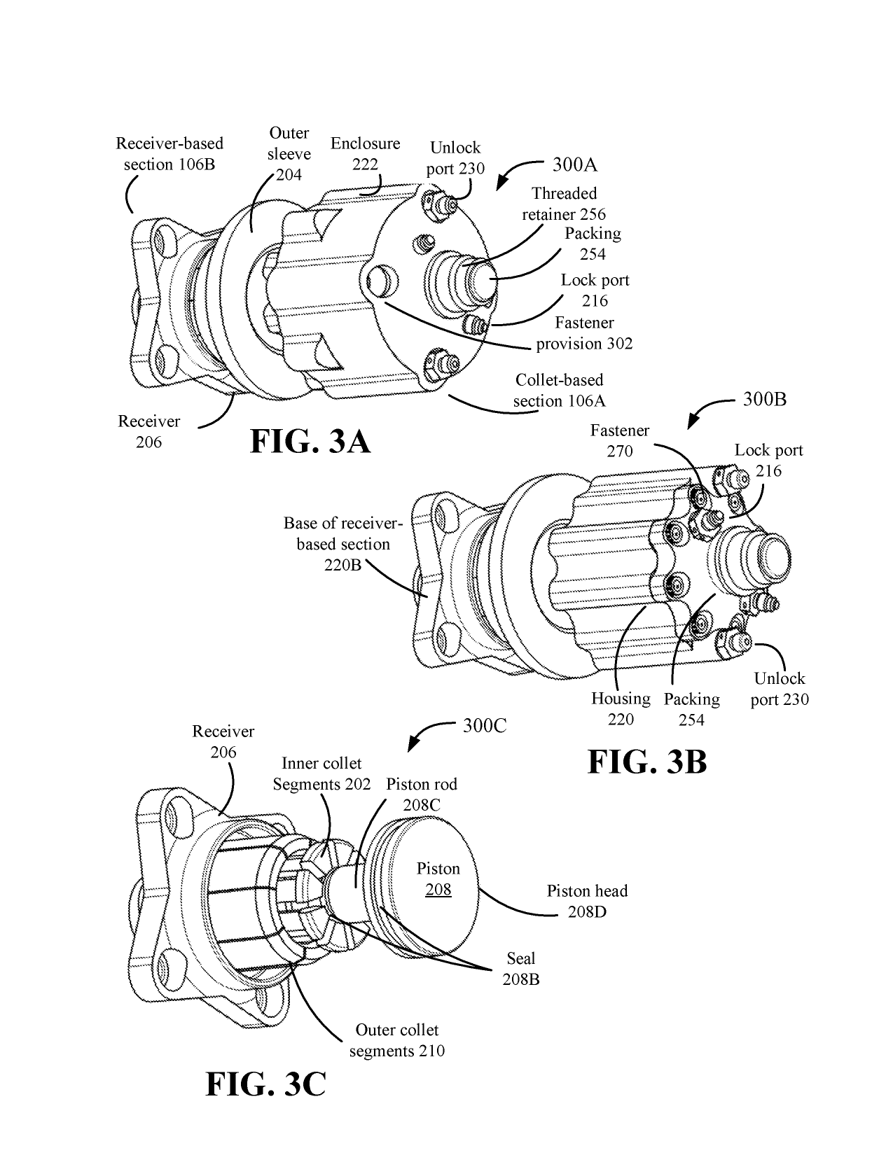

FIG. 3A illustrates external aspects 300A of an enclosure of a collet-supported or based release mechanism, in accordance with a further non-limiting aspect of the present disclosure. As illustrated, an enclosure 222 may protect the piston 208 and housing 220 features of the collet-supported or based URM. The enclosure 222 may include provisions, such as the fastener provision 302 for fasteners 270 (as in FIGS. 2F and 3B). There may be other provisions for the lock ports 216, the unlock ports 230, and for the packing 254 to receive a threaded retainer 256. There may be bases 220A, 220B (as in FIGS. 2A and 2B) on the receiver-based section 106B and the collet-based section 106A to receive fasteners to associate the receiver-based section 106B and the collet-based section 106A to respective features 108A, 110A, 110B of a launch vehicle 110 or a launchpad 108.

FIG. 3B illustrates aspects 300B of a housing in a collet-supported or based release mechanism, in accordance with a further non-limiting aspect of the present disclosure. FIG. 3B illustrates the housing 220 and the packing 254, with the enclosure 222 removed. The housing 220 and the packing 254 may be associated together by the fasteners 270 through respective provisions but accessible from the enclosure 222, as described in connection with at least FIG. 3A. FIG. 3B also illustrates the lock ports 216 and the unlock ports 230 for access to internals between the piston 208 and the housing 220 from outside the housing 220.

FIG. 3C illustrates aspects 300C of a piston in a collet-supported or based release mechanism, in accordance with a further non-limiting aspect of the present disclosure. The aspects 300C in FIG. 3C include details for the piston 208. The piston 208 may include a piston rod 208C and a piston head 208D. There may be piston seals 208B (also in FIG. 2D) to retain media received to a top of the piston head 208D or to a bottom of the piston head 208D. FIG. 3C also illustrates the outer collet segments 210 of the receiver 206 in a bias which is inwards (towards the piston 208) and which is against the inner collet segments 202.

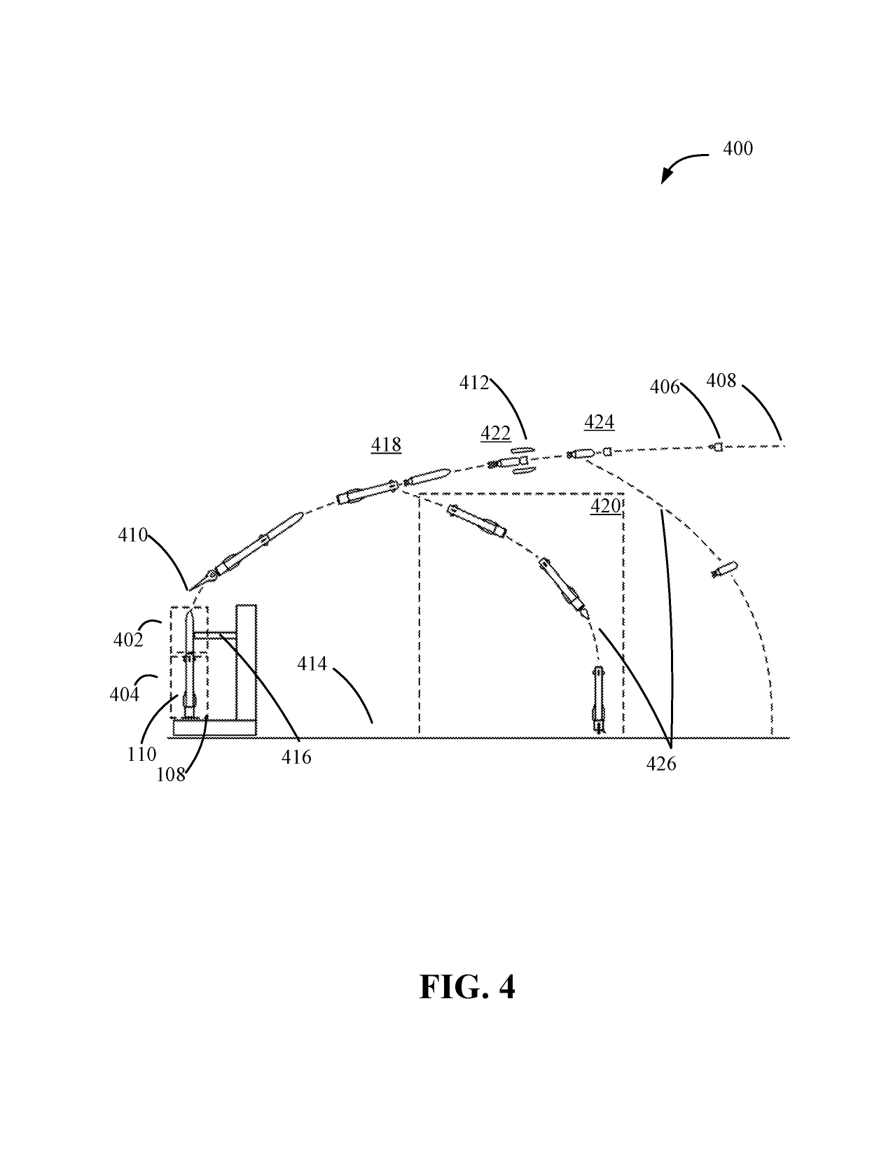

FIG. 4 illustrates an example space mission 400 having components benefiting from the collet-supported or based release mechanism, in accordance with a further non-limiting aspect of the present disclosure. A launch vehicle 110 may include at least the upper stage 402 with the payload module (and the upper stage propulsion module in FIG. 1), which may be on top of a lower stage (or first stage) propulsion module 404. The launch vehicle feature 110A, 110B (in FIG. 1) may be a payload module, the upper stage 402, or the lower stage propulsion module 404, which may be subject to connections for media transfer and which may benefit from the collet -supported or based release mechanism herein. In the example of FIG. 4, the component may be interchangeably referenced as a payload module. In another example, the components may be the upper stage propulsion module. The space mission 400 may be for placement or guidance of payload 406 to a suitable orbit 408. In one example, there may be multiple payloads for different intended orbits.

The launch vehicle 110 may travel through an initial trajectory or flight path 410 for a period of time. The payload module having the one or more payload 406 may include fairings 412 to enclose the payload 406. The fairings 412 may have sections which may be subject to separation to allow release of the one or more payload 406. In one example, a payload module or the payload 406 may be one which, without limitations, docks with a space station or performs space-related investigations, prior to re-entry and landing back on Earth’s surface 414 or without returning back to the Earth’s surface 414, as part of the space mission 400.

There may be maneuvers associated with components of the launch vehicle 110. There may be pre-flight activities to be performed before and/or when the launch vehicle 110 is prepared on a launchpad 108. The pre-flight activities may include media transfer and may use connections through umbilical 416 having umbilical panels and collet-supported or based release mechanism herein. A payload 406 may include satellites and other components. Such satellites or other components may be loaded into dispensers or other deployment aspects of the payload module.

The space mission 400 may include a liftoff of the payload module from the launchpad 108. After liftoff and after an initial time span, the launch vehicle 110 may proceed in the initial trajectory or flight path 410 as part of an ascent phase. After ascending for a time span, a first stage separation 418 may occur. In the first stage separation 418, a payload module may separate from a lower stage propulsion module 404. After the first stage separation 418, the lower stage propulsion module 404, which may proceed along a different trajectory or flight path 426 and may perform a reorientation maneuver, followed by a landing burn, and a landing, which are all generally represented by a block 420 representation in FIG. 4.

A fairing jettison phase 422 may occur at a time which may be just prior to, during, or just after the first stage separation 418. While the fairing jettison phase 422 may occur with respect to the lower stage propulsion module 404, any dispenser associated with the lower stage propulsion module 404 may also be caused to eject any component for telemetry at this phase or between this phase and the prior first stage separation 418. Such a component may include an analog to digital converter (ADC) and other components. This may be so that the ADC and the other components may have a same or similar speed and trajectory (e.g., velocity) as lower stage propulsion module 404 and may be a parallel trajectory relative to the illustrated trajectory of the lower stage propulsion module 404.

The payload 406 may separate from the payload module in a payload or second separation stage 424. The payload 406 may proceed in micro-gravity (also referred to by the approximation “zero-gravity”). For certain trajectories, there may be more time required to reach a suitable orbit 408 to continue docking with a space station or performing other space-related investigations and prior to any potential re-entry. The space mission 400 may end when payload 406 is set in orbit or returns to the Earth’s surface 414 at a suitable time. A payload module may carry equipment to and from space, samples to space, samples from space, or may be a crew module for crew or passengers.

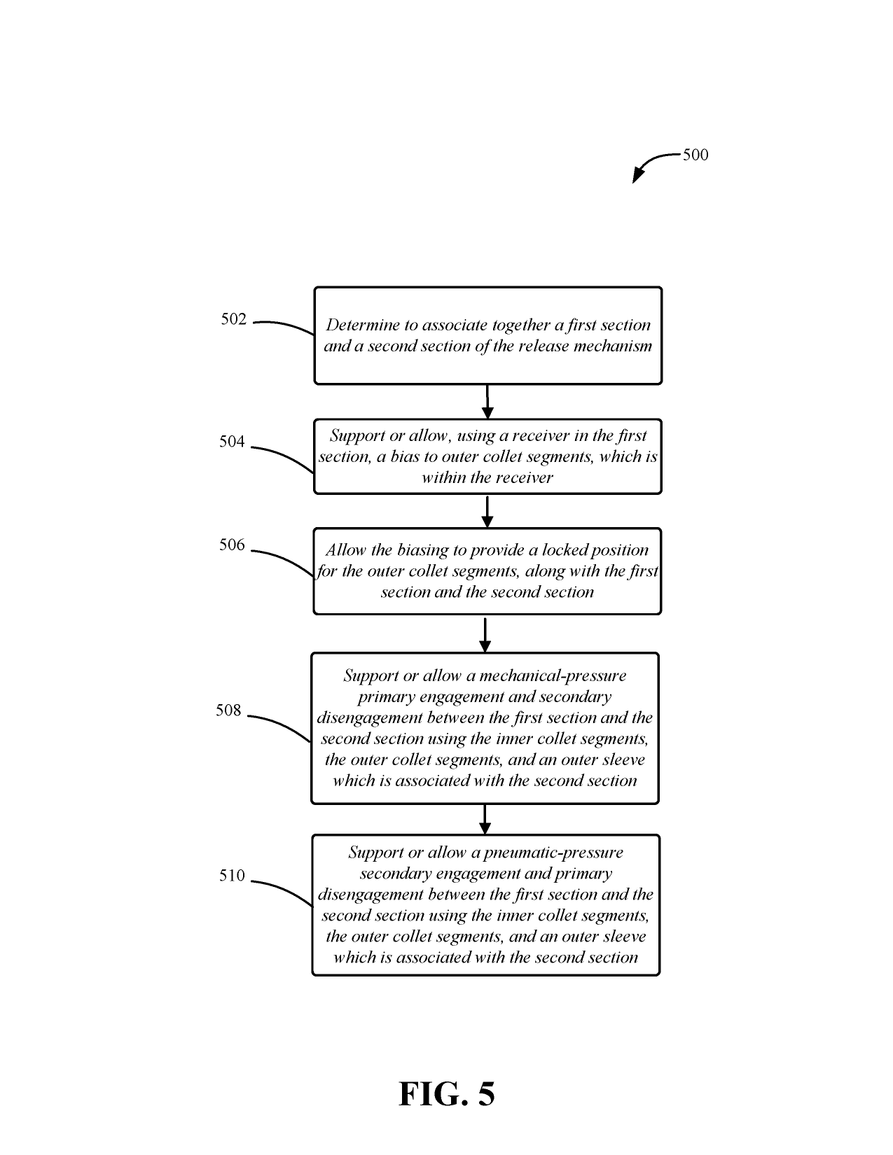

FIG. 5 illustrates a method 500 associated with a system used for collet-supported or based release mechanism, in accordance with a further non-limiting aspect of the present disclosure. The method 500 may include a step to determine 502 to associate together a first section and a second section of the release mechanism. The first section may be a receiver-based section and the second section may be a collet-based section. The method 500 may include a step to support or allow 504, using a receiver in the first section, a bias to outer collet segments, which is within the receiver. The method 500 may include a step to allow 506 the biasing to provide a locked position for the outer collet segments, along with the first section and the second section. The method 500 may include a step to support or allow 508 a mechanical-pressure primary engagement and secondary disengagement between the first section and the second section using the inner collet segments, the outer collet segments, and an outer sleeve which is associated with the second section. The method 500 may include a step to support or allow 510 a pneumatic-pressure secondary engagement and primary disengagement between the first section and the second section using the inner collet segments, the outer collet segments, and an outer sleeve which is associated with the second section.

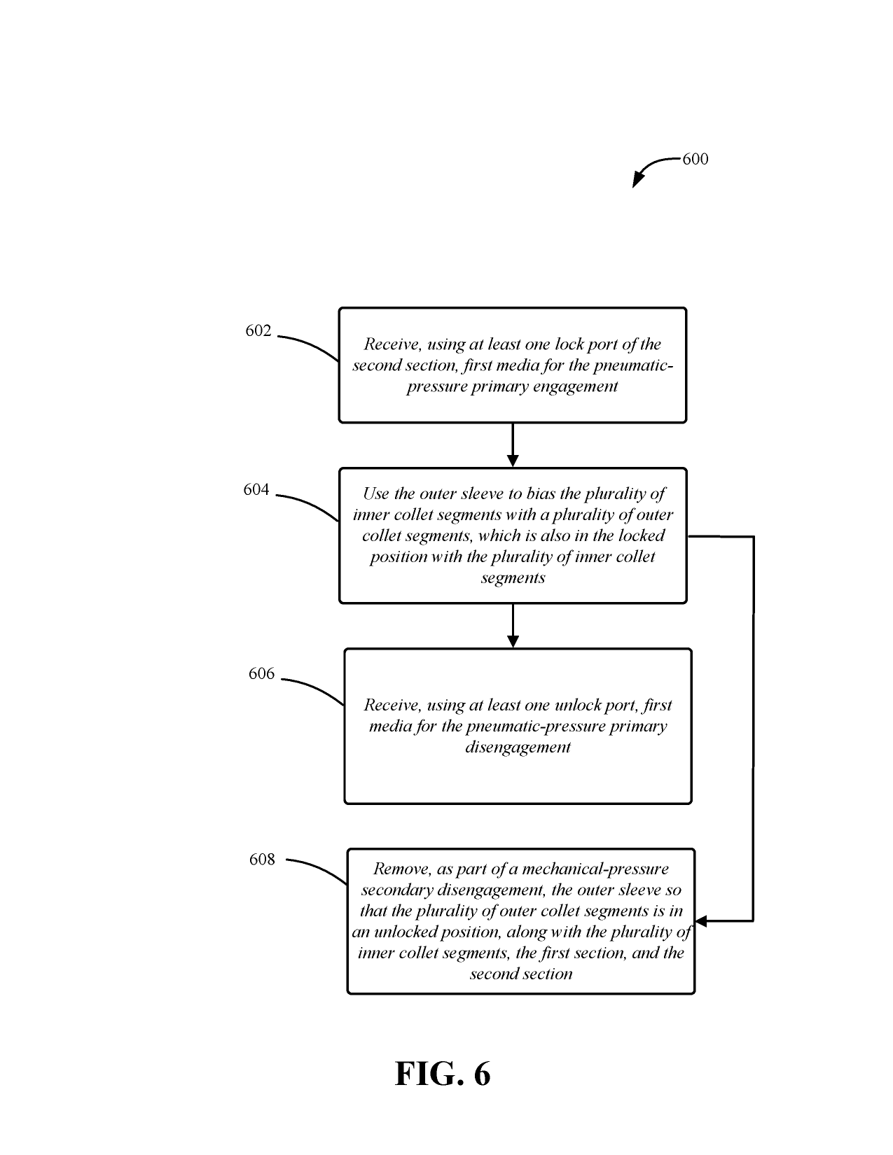

FIG. 6 illustrates a further method 600 associated with a system used for collet-supported or based release mechanism, in accordance with a further non-limiting aspect of the present disclosure. The method 600 in FIG. 6 may be used with or separately from the method 500 in FIG. 5. For example, the method 600 in FIG. 6 may use a piston, an outer sleeve, and inner and outer collet segments with one or more of the mechanical-pressure primary engagement, a pneumatic-pressure secondary engagement, a pneumatic-pressure primary disengagement, or the mechanical-pressure secondary disengagement herein. For example, the method 600 may include a step to receive 602, using at least one lock port of the second section, first media for the pneumatic-pressure primary engagement.

The method 600 may include a step to use 604 the outer sleeve to bias the plurality of inner collet segments with a plurality of outer collet segments, which is also in the locked position with the plurality of inner collet segments, as part of the mechanical-pressure primary engagement described in at least step 510 in FIG. 5. The order of the steps may be changed, with the media applied for a pneumatic-pressure secondary engagement before the mechanical-pressure primary engagement. The method 600 may include a step to receive 606, using at least one unlock port, first media for the pneumatic-pressure primary disengagement. The step 606 may follow as a routine transfer of media being completed. The method 600 may include a step to remove 608, as part of a mechanical-pressure secondary disengagement, the outer sleeve so that the plurality of outer collet segments is in an unlocked position, along with the plurality of inner collet segments, the first section, and the second section. The step 608 may follow as an emergency when the routine transfer is interrupted, incomplete, or when the step 606 for the second media to perform the pneumatic-pressure primary disengagement has failed.

The methods 500, 600 may include a further step or a sub-step to determine a ground-side feature having the second section to be associated with a launch vehicle having the first section. The methods 500, 600 may include a further step or a sub-step to associate together the first section and the second section. This may be based in part on the locked position for the outer collet segments, along with the first section and the second section. The methods 500, 600 may include a further step or a sub-step to use a threaded retainer which is configured to remove loading on the release mechanism in the locked position for the first section and the second section.

The present disclosure has been described with reference to various exemplary and illustrative aspects. The aspects described herein are understood as providing illustrative features of varying detail of various aspects of the disclosed disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed disclosure. Accordingly, it will be recognized by persons having ordinary skill in the art that various substitutions, modifications or combinations of any of the exemplary aspects may be made without departing from the scope of the disclosure. In addition, persons skilled in the art will recognize or be able to ascertain using no more than routine experimentation, many equivalents to the various aspects of the disclosure described herein upon review of this specification. Thus, the disclosure is not limited by the description of the various aspects, but rather by the claims.

What is claimed is:

1. A system for release mechanism, the system comprising:
a first section and a second section;
a receiver in the first section configured to allow or support bias to a plurality of outer collet segments, which is within the receiver, wherein the bias positions the plurality of outer collet segments in a locked position along with the first section and the second section; and
a plurality of inner collet segments and an outer sleeve of the second section, the plurality of inner collet segments and the outer sleeve configured to support or allow a mechanical-pressure primary engagement and secondary disengagement between the first section and the second section and through the receiver, and configured to support or allow a pneumatic-pressure secondary engagement and primary disengagement between the first section and the second section and through the receiver.

2. The system of claim 1, further comprising:
a launch vehicle to comprise the first section; and
a ground-side feature to comprise the second section.

3. The system of claim 1, further comprising:
a threaded retainer configured to remove loading on the release mechanism in the locked position for the first section and the second section.

4. The system of claim 1, further comprising:
at least one lock port configured to receive first media for the pneumatic-pressure secondary engagement; and
at least one unlock port configured to receive second media for the pneumatic-pressure primary disengagement.

5. The system of claim 1, wherein the outer sleeve biases, as part of the mechanical-pressure primary engagement, the plurality of inner collet segments with a plurality of outer collet segments, which is also in the locked position with the plurality of inner collet segments, and wherein, when the outer sleeve is removed as part of the mechanical-pressure secondary disengagement, the plurality of outer collet segments is further to be in an unlocked position, along with the plurality of inner collet segments, the first section, and the second section.

6. The system of claim 1, further comprising:
a piston to receive media for the pneumatic-pressure secondary engagement and primary disengagement; and
a housing to allow movement of the piston therein and to support angular movement for the plurality of inner collet segments, wherein at least one of the angular movement causes the plurality of inner collet segments to collapse as part of the pneumatic-pressure primary disengagement.

7. The system of claim 6, further comprising:
a knob at an end of the piston and which is between the plurality of inner collet segments, wherein the outer sleeve is to retain the plurality of outer collet segments and the plurality of inner collet segments in the locked position as part of the mechanical-pressure primary engagement, wherein, when the outer sleeve is removed as part of the mechanical-pressure secondary disengagement, the plurality of outer collet segments is further to be in an unlocked position, along with the plurality of inner collet segments, the first section, and the second section.

8. The system of claim 6, further comprising:
packing comprising a lock port access and attached to the housing, the packing to retain the piston within the housing and to provide space to receive the media.

9. The system of claim 1, wherein a first pressure associated with the mechanical-pressure secondary disengagement is higher than a second pressure associated with one or more of the pneumatic-pressure secondary engagement or the mechanical-pressure primary engagement.

10. A collet-based section of an umbilical release mechanism (URM), the collet-based section comprising a plurality of inner collet segments and supported by an outer sleeve, the plurality of inner collet segments and the outer sleeve configured to support or allow a mechanical-pressure primary engagement and secondary disengagement between the collet-based section and a receiver-based section and through a receiver of the receiver-based section, and configured to support or allow a pneumatic-pressure secondary engagement and primary disengagement between the collet-based section and through a receiver of a receiver-based section.

11. The collet-based section of claim 10, further comprising:
a threaded retainer configured to remove loading on the URM in a locked position for the receiver-based section and the collet-based section.

12. The collet-based section of claim 10, further comprising:
at least one lock port configured to receive first media for the pneumatic-pressure secondary engagement; and
at least one unlock port configured to receive second media for the pneumatic-pressure primary disengagement.

13. The collet-based section of claim 12, further comprising:
a piston and a knob at an end of the piston, wherein the knob is between a plurality of outer collet segments of the receiver-based section, as part of the pneumatic-pressure secondary engagement, wherein the outer sleeve is to retain the plurality of inner collet segments with the plurality of outer collet segments in a locked position as part of the mechanical-pressure primary engagement, and wherein, when the outer sleeve is removed as part of the mechanical-pressure secondary disengagement, the plurality of outer collet segments is further to be in an unlocked position, along with the plurality of inner collet segments, the receiver-based section, and the collet-based section.

14. The collet-based section of claim 10, further comprising
a piston to receive media for the pneumatic-pressure secondary engagement and primary disengagement; and
a housing to allow movement of the piston therein and to support angular movement for the plurality of inner collet segments, wherein at least one of the angular movement causes the plurality of inner collet segments to collapse as part of the pneumatic-pressure primary disengagement.

15. The collet-based section of claim 10, wherein the outer sleeve biases, as part of the mechanical-pressure primary engagement, the plurality of inner collet segments with a plurality of outer collet segments, which is in a locked position with the plurality of inner collet segments, and wherein, when the outer sleeve is removed as part of the mechanical-pressure secondary disengagement, the plurality of outer collet segments is further to be in an unlocked position, along with the plurality of inner collet segments, the receiver-based section, and the collet-based section.

16. A method for a release mechanism, the method comprising:
determining to associate together a first section and a second section of the release mechanism;
supporting or allowing, using a receiver in the first section, a bias to a plurality of outer collet segments, which is within the receiver, to position the outer collet segments in a locked position along with the first section and the second section;
supporting or allowing a mechanical-pressure primary engagement and secondary disengagement between the first section and the second section using a plurality of inner collet segments, the plurality of outer collet segments, and an outer sleeve which is associated with the second section; and
supporting or allowing a pneumatic-pressure secondary engagement and primary disengagement between the first section and the second section using the plurality of inner collet segments, the plurality of outer collet segments, and the outer sleeve.

17. The method of claim 16, further comprising:
determining a ground-side feature comprising the second section to be associated with a launch vehicle comprising the first section; and
associating together the first section and the second section based in part on the locked position for the plurality of outer collet segments, along with the first section and the second section.

18. The method of claim 16, further comprising:
using a threaded retainer configured to remove loading on the release mechanism in the locked position for the first section and the second section.

19. The method of claim 16, further comprising one or more of:
receiving, using at least one lock port of the second section, first media for the pneumatic-pressure secondary engagement; or
receiving, using at least one unlock port, second media for the pneumatic-pressure primary disengagement.

20. The method of claim 16, further comprising:
using the outer sleeve, as part of the mechanical-pressure primary engagement, to bias the plurality of inner collet segments with a plurality of outer collet segments, which is also in the locked position with the plurality of inner collet segments; and
removing the outer sleeve, as part of the mechanical-pressure secondary disengagement, so that the plurality of outer collet segments is in an unlocked position, along with the plurality of inner collet segments, the first section, and the second section.
